(19) United States
(12) Patent Application Publication
(10) Pub. No.: US 2007/0131466 A1
(43) Pub. Date: Jun. 14, 2007

(54) Work machine with electrical and hydraulic service centers

(76) Inventors: Timothy M. Gutzwiller, Oswego, IL (US); Bill Enders, Tinley Park, IL (US); Martin J. Keane, Oak Lawn, IL (US); Kevin R. Paarlberg, Sycamore, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/299,936

(22) Filed: Dec. 12, 2005

(51) Int. Cl. B62D 31/00; B21D 39/03

(52) U.S. Cl. 180/89.1; 29/428; 180/311

(57) ABSTRACT

An articulated work machine, such as a wheel loader, includes many regularly serviced hydraulic points, such as a hydraulic fluid filter, a case drain filter, a transmission fluid filter and brake accumulators that are grouped and mounted in a common service center subassembly, which may be preassembled and then later attached to the work machine chassis when the machine is being built. Likewise, an electrical service center subassembly might include a battery box, relays and an emergency shutoff switch that can be preassembled and attached to the machine chassis as a unit at the time that the work machine is being built. The respective hydraulic and electrical service centers are attached to the work machine chassis underneath cab access steps on opposite sides of the machine. This strategy allows for a potential reduction in cost during the work machine manufacture, and also better facilitates servicing of the hydraulic and/or electrical service points at an easily accessible and common location(s).

### TECHNICAL FIELD

The present disclosure relates generally to servicing systems associated with a work machine, and more particularly to grouping hydraulic and/or electrical servicing points at an easily accessible common service center on a work machine, such as a wheel loader.

### BACKGROUND

Work machines often include many electrical and hydraulic systems that require periodic servicing and/or monitoring. For instance, a typical work machine might include implement hydraulic systems that include pumps and hydraulic cylinders for operating the implements associated with the work machine. The implement hydraulic system would typically include a case drain filter for catching debris leaving the pump, and a hydraulic fluid filter for continuously trapping dirt, dust and other particulate matter that finds its way into the hydraulic system. An internal combustion engine which powers the work machine would typically include a lube oil system having lube oil that passes through a filter. A transmission would typically include circulated transmission fluid that passes through a filter. Hydraulically actuated service brakes may include gas accumulators that might require periodic inspection and recharging with gas if the pressure is low. In addition, some work machines include an electrohydraulic parking brake system with a parking brake valve that may require periodic inspection. Finally, these hydraulic fluid systems may require a means of draining and refilling on a periodic basis. These hydraulic fluid systems define a plurality of service points where inspection and maintenance processes are performed by a technician. In prior art work machines, these service points are distributed throughout the machine and may be difficult to identify and access, requiring an excess amount of time to perform the inspection and maintenance processes.

The electrical system may, on the other hand, include a variety of relays and possibly a main shut down switch. Switches to raise and lower a hood and any waste or other guards may also be required. A jump start receptacle may also be included. In addition, the electrical system typically will include a battery that should be readily accessible, and may require servicing and/or periodic replacement. Thus, the electrical system also defines a plurality of service points where inspection and maintenance processes are performed by a technician. In prior art work machines, these service points are distributed throughout the machine and may be difficult to identify and access, requiring an excess amount of time to perform the inspection and maintenance processes.

Those skilled in the art will also appreciate that servicing the various service points of the hydraulic and electrical systems of a work machine can sometimes be inconvenient when the machine is hot. For instance, some of the service points in prior art work machines may be located near relatively high temperature items, such as the engine. A technician may have to wait until the engine cools before accessing these service points.

The present disclosure is directed to one or more of the problems set forth above.

### SUMMARY OF THE DISCLOSURE

In one aspect, a work machine includes a front portion that is joined to a back portion via an articulation joint. The front portion includes a front frame, a pair of front wheels and a moveable bucket. The back portion includes a back frame, a pair of back wheels, an engine and a step leading to a cab. A system comprises one of a plurality of hydraulic components and a plurality of electrical components. The system includes a plurality of service points. A plurality of the service points are grouped at a common service center underneath the step.

In another aspect, the common service center is a hydraulic service center that includes a service center box with a chassis mount and at least one door. A plurality of hydraulic service points are attached inside the box, and the hydraulic service points include a hydraulic fluid filter, a case drain filter, a transmission fluid filter and at least one brake accumulator.

In still another aspect, a method of assembling a work machine includes attaching a hydraulic service center underneath a step of a back portion of a work machine body, which includes a front portion joined to the back portion via an articulation joint. A plurality of hydraulic fluid system hoses are attached to at least one hydraulic filter mounted inside the hydraulic service center. At least one brake line hose is attached to at least one brake accumulator mounted inside the hydraulic service center. In addition, at least one transmission fluid hose is attached to a transmission filter mounted inside the hydraulic service center.

### BRIEF DESCRIPTION OF THE DRAWINGS

FIG. 1 is a right side diagrammatic view of a work machine showing a hydraulic service center;

FIG. 2 is an isometric close up view of the opened hydraulic service center mounted on the work machine of FIG. 1;

FIG. 3 is a different isometric diagrammatic view of the hydraulic service center of FIG. 2;

FIG. 4 is an isometric exterior view of the hydraulic service center of FIG. 2;

FIG. 5 is a partial left side diagrammatic view of the work machine of FIG. 1 showing an electrical service center;

FIG. 6 is a partial interior isometric view of a relay box which may form part of the electrical service center of FIG. 5;

FIG. 7 is an exterior view of the relay box of FIG. 6; and

FIG. 8 is an isometric view of the electrical service center of FIG. 5.

### DETAILED DESCRIPTION

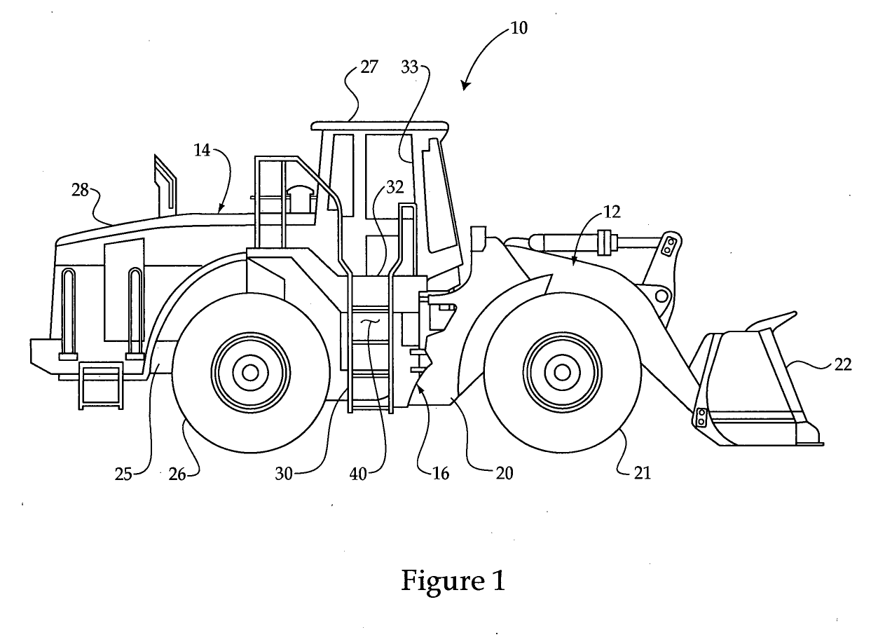

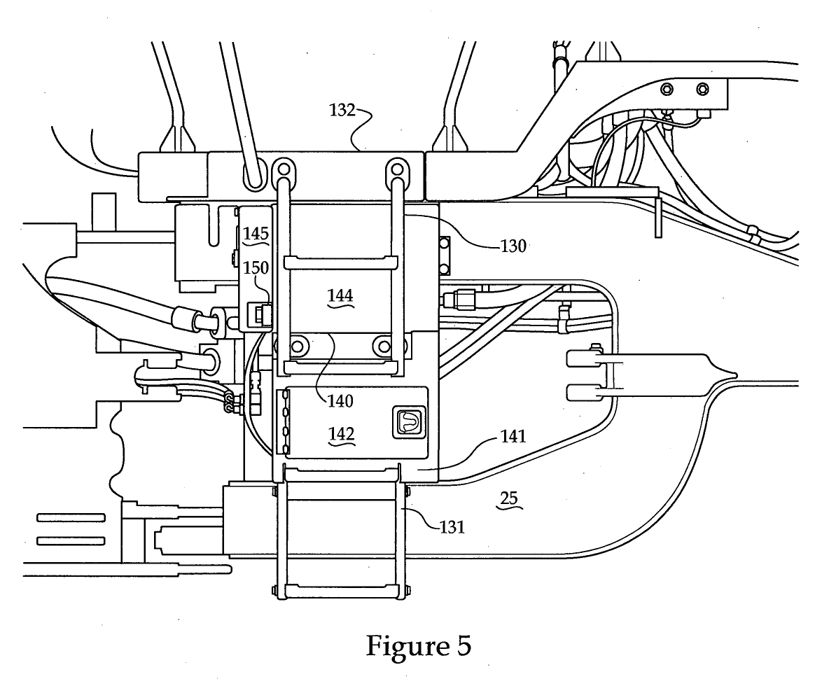

Referring to FIGS. 1 and 5, a work machine 10 is illustrated as an articulated wheel loader with a chassis that includes a front portion 12 joined to a back portion 14 via an articulation joint 16. Articulation joint 16 allows front frame 20 to pivot about a vertical axis with respect to back frame 25. Steering of work machine 10 may be accomplished with appropriate actuators via articulation joint 16 in a conventional manner. The front portion 12 includes a front frame 20, a pair of front wheels 21 and a moveable bucket 22. The back portion 14 includes a back frame 25, a pair of back wheels 26, an operator station 27 and an engine 28. Access to the operator station 27 or cab can be gained from either the right hand side shown via ladder 30, step 32 and door 33, or via a left hand side (FIG. 5) via another ladder 130, 131, a step 132 and a left side door (not shown). The operator ascends to the operator station 27 on the right side by climbing up the ladder 30 and standing on step 32. Door 33 can then be opened and the operator steps into the operator station 27. Ascending on the left side can be done in a similar fashion. On the right hand side of work machine 10, underneath step 32 is mounted a hydraulic service center 40 that is more thoroughly described infra. Likewise, work machine 10 may include an electrical service center 140 mounted on the opposite side of work machine 10 underneath a step 132 adjacent the ladder 130 on the left hand side.

Work machine 10 includes hydraulic and electrical systems that support various aspects of the machine. These systems are mounted on, or carried by, front frame 20 and/or back frame 25 in a conventional manner. For instance, the hydraulic system may include, but is not limited to, pumps, hoses, filters, valves, fittings, accumulators, heads, sensors, gauges, and any other known hydraulic system components. Likewise, the electrical system may include, but is not limited to, wires, a jump start receptacle, batteries, lights, gauges, hood and other guard actuation switches, sensors, actuators, motors, generators, relays, fuses, processors, memory and any other known electrical system components. The hydraulic system may include one or more separate fluid circuits, such as one or more wheel brake actuator circuits, one or more hydraulic implement actuator circuits, a transmission fluid circuit, one or more lubrication fluid circuits, and any other fluid circuits known in the work machine art. Likewise, the electrical system may include a plurality of separate circuits, such as one or more associated with electrical power, various sensor circuits, command and control circuits and any other electrical circuits known in the work machine art. The hydraulic and electrical systems define several service points where inspection and maintenance operations may need to be performed by a service technician.

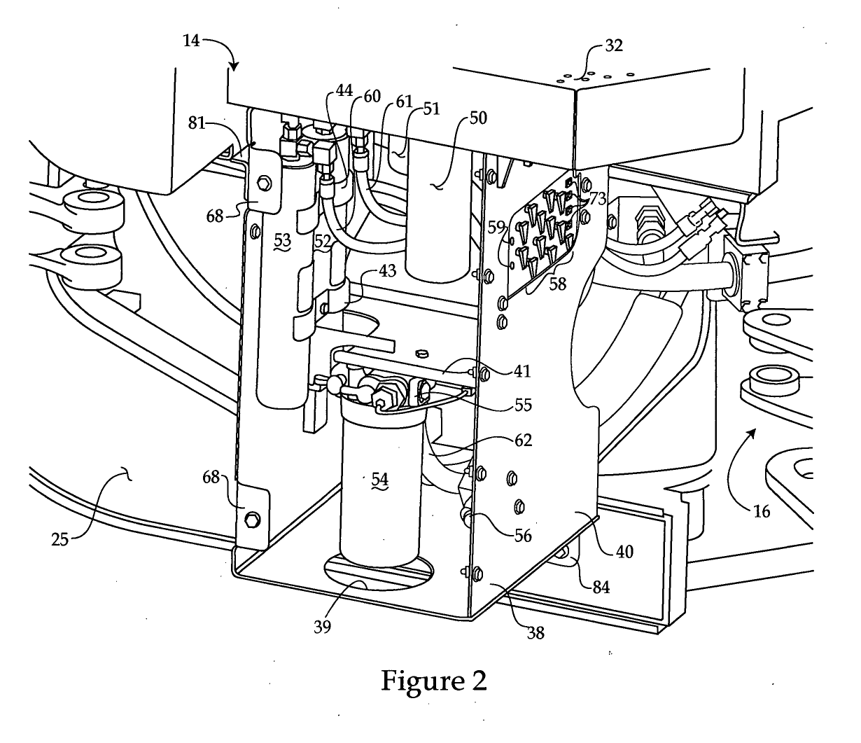

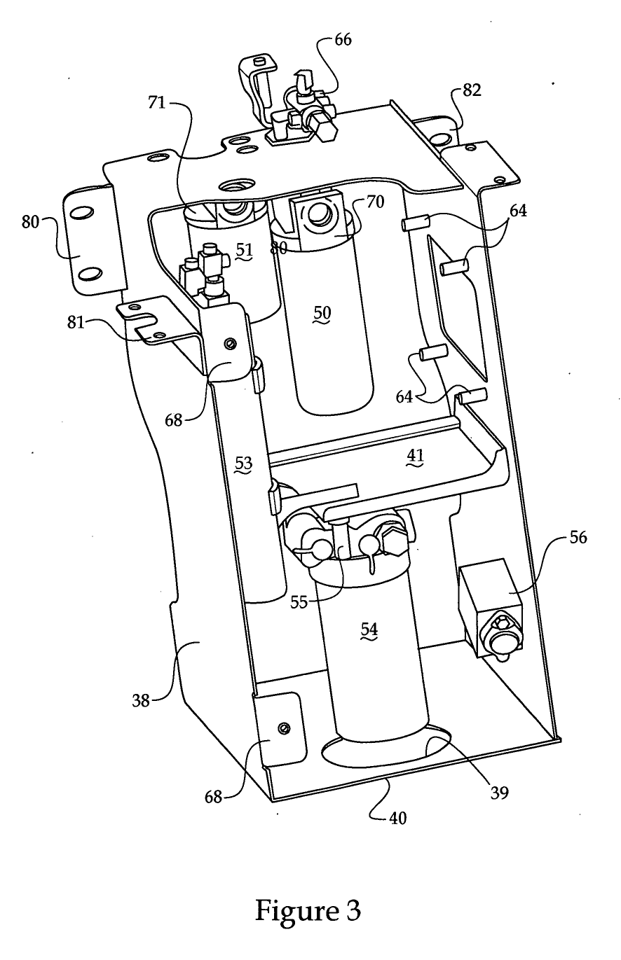

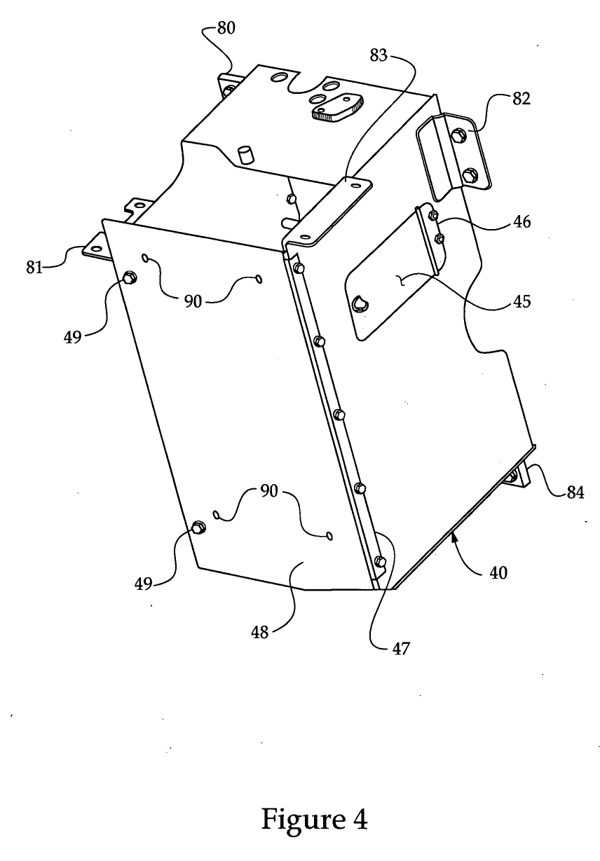

Referring now to FIGS. 2, 3 and 4, various service points grouped together in hydraulic service center 40 can be seen. Hydraulic service center 40 may be based upon any suitable structure such as an open frame, a frame with panels attached to create an enclosed, or partially enclosed box, or a formed sheet metal box frame 38 as illustrated. FIG. 4 shows an exterior view of the hydraulic service center 40 as it might appear as a subassembly before being installed on a work machine. In the illustrated embodiment, the frame 38 of hydraulic service center 40 has a generally open back side that faces the work machine chassis and allows the various hydraulic fluid hoses to enter the hydraulic service center from a chassis side of the machine. Frame 38 includes mounts 80, 81, 82, 83 and 84 that facilitate attachment to the work machine 10. Different work machines in a product line, such as a product line of different sized wheel loaders, might include similar mounting points to accommodate mounts 80, 81, 82, 83 and 84, and whatever hydraulic servicing points that suit a particular model.

The frame 38 of hydraulic service center 40 includes a small diagnostic tap door 45 that is mounted on a hinge 46, and may include either a latch or a lock point. Frame 38 also includes a service main door 48 that may be mounted on a set of hinges 47, and may be kept in a closed position via some suitable means, such as via bolts 49 that mate to flanges 68 or a latch or a lock (FIG. 2). A ladder 30 (FIG. 1) can be attached to the service main door 48 of hydraulic service center 40 (FIG. 4) via ladder mounts 90. The various internal service points of hydraulic service center 40 can be preassembled, and brought to the work machine assembly line as a subassembly. Furthermore, a substantially identical hydraulic service center shell can be used across a product line and include mounting features suitable for the servicing points that differ to some extent from one work machine to another in a product line. For instance, a line of wheel loaders might include identically shaped and sized hydraulic service centers with some identical internal features, and some that may differ from one work machine model to another. Different applications may include an identical hydraulic fluid filter head, but may have attached different hydraulic fluid filters. In other instances, a completely different filter head or other point could use the same or different mounting features in the hydraulic service center 40.

The hydraulic service center 40 may also include first and second brake accumulators 52 and 53 that are supported by appropriate brackets 43 and 44. Those skilled in the art will appreciate the brake accumulator 52 and 53 provide a means of storing pressure energy for use by the braking system via a movable piston and pressurized gas. The accumulators include a valve for adjusting the gas pressure. A transmission filter head 55 may be connected to transmission fluid hoses 62 in a conventional manner and mounted under a platform stiffener 41. A transmission filter 54 may also be pre-assembled to filter head 55. Although not necessary, frame 38 might also include an access opening 39 so that transmission filter 54 may be easily removed and changed without opening the main service door 48. Those skilled in the art will appreciate that transmission fluid is continuously circulated through transmission filter 54, which removes dirt, dust and other particulate matter from the transmission fluid. Thus, transmission filter 54 needs to be periodically replaced based upon the operating environment of the work machine, its duty cycle and other factors known in the art. Likewise, brake accumulators 53 and 52 are connected to brake line hoses 60 and 61, respectively in a conventional manner. In addition, a hydraulic fluid filter head 70 and case drain filter head 71 may be connected to other hydraulic fluid hoses in a conventional manner, and may be mounted to any inside surface of frame 38. Those skilled in the art will appreciate that the case drain filter 51 captures debris leaving the hydraulic pump (not shown) and must be periodically serviced to maintain the hydraulic system in good working order. In addition, a separate hydraulic filter 50 is utilized to capture dust, dirt and other particulate matter that may find its way into the hydraulic system due to the operating environment and/or duty cycle of the work machine. Those skilled in the art will appreciate that this filter should also be periodically replaced to maintain the hydraulic system in good working order. In the illustrated embodiment, filter heads 70 and 71 are mounted on an underside of the top surface of frame 38. These hoses enter in through the opened side of the frame 38 of the hydraulic service center 40 adjacent the work machine frame 25. The service center sub-assembly 40 may or may not arrive at a work machine assembly line with case drain filter 51, hydraulic filter 50 or transmission filter 54 attached to their respective filter heads 71, 70 or 55.

The hydraulic service center might also include an ecology drain 56 that facilitates evacuation and refilling of certain hydraulic fluid circuits. In addition, a hydraulic parking brake valve 66 may also be mounted inside or outside, as shown, of the frame 38 of the hydraulic service center 40. A separate hydraulic fluid hose line (not shown) would fluidly connect the parking brake valve 66 to the appropriate parking brake cylinder(s) on the work machine. The hydraulic service center also may include a diagnostic pressure tap group mount 64 adjacent the small diagnostic tap door 45. In particular, a panel 42 is mounted on diagnostic pressure tap group mount 64 so that one face of the panel 42 is adjacent the small diagnostic tap door 45. Before mounting that panel 42, a plurality of diagnostic pressure taps 58 may be attached to the opposite side of panel 42. Customer optional attachment diagnostic pressure taps 59, which are shown as unused in this embodiment, may also be available. In addition, this panel might include one or more grease zerks 73 that allow various aspects of the work machine 10 to be lubricated from hydraulic service center 40. Other attachment hydraulic components might also be mounted on frame 38 of service center 40, including but not limited to a quick coupler shut-off valve, and an axle oil cooling valve. Those skilled in the art will recognize that a hydraulic service center according to the present disclosure may include any combination of servicing points known in the art. As used in this application, a servicing point means a feature that is expected to need periodic replacement and/or inspection (e.g. fluids, filters, batteries, fuses, etc.), allows access to diagnose the status of a feature (e.g. diagnostic pressure taps), reset features (e.g., switches), and other conventional features such as a jump start receptacles and the like; however not a feature that could break but is not expected to require regular and periodic access or maintenance for the intended proper operation of the work machine.

Referring now to FIGS. 5 through 8, work machine 10 may also include an electrical service center 140 mounted on back frame 25 underneath step 132, on a side opposite from that of the hydraulic service center 40. Step 132 is adjacent a left side cab access door (not shown). The left hand side of work machine 10 may also include an optional tool box 141 mounted underneath electrical service center 140. Tool box 141 may include an access door 142 between rungs of ladders 130 and 131. The electrical service center 140 may include a battery box 144, a relay box 145 and a main shut down switch 150. Those skilled in the art will appreciate that other electrical service features might also be included depending upon the needs of a particular work machine. For instance, the electrical service center 140 might also include other servicing features such as a hood switch, a waste guard belly switch (if used), a main disconnect, and possibly even jump start receptacles for jump starting the work machine engine starter. In addition, fuses, if any, might also be located in the electrical service center 140 without departing from the scope of the present disclosure.

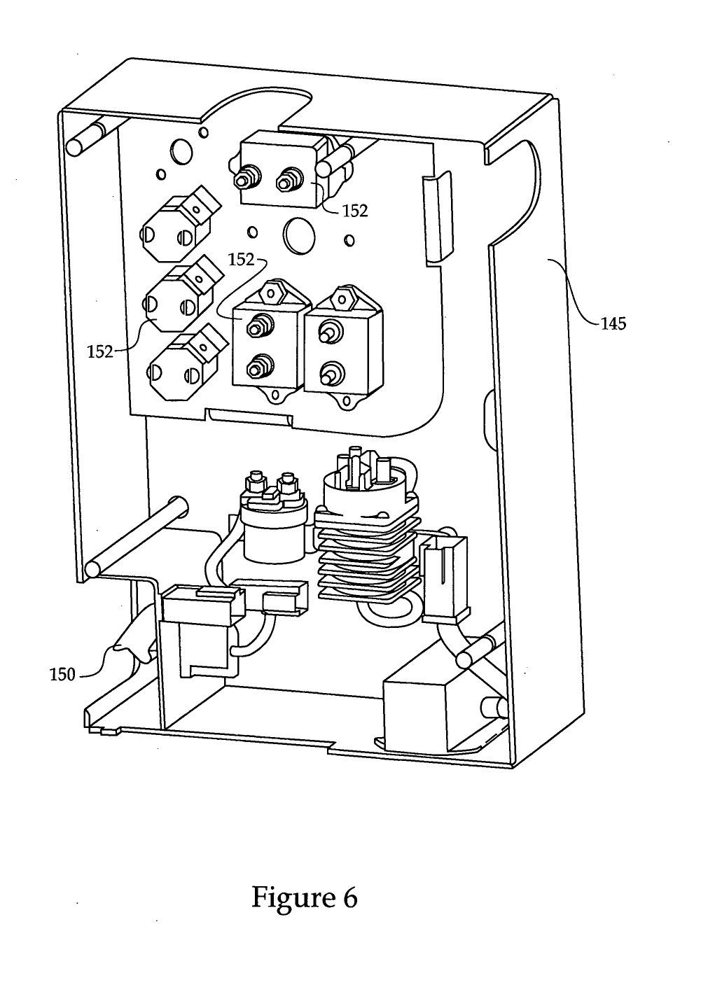

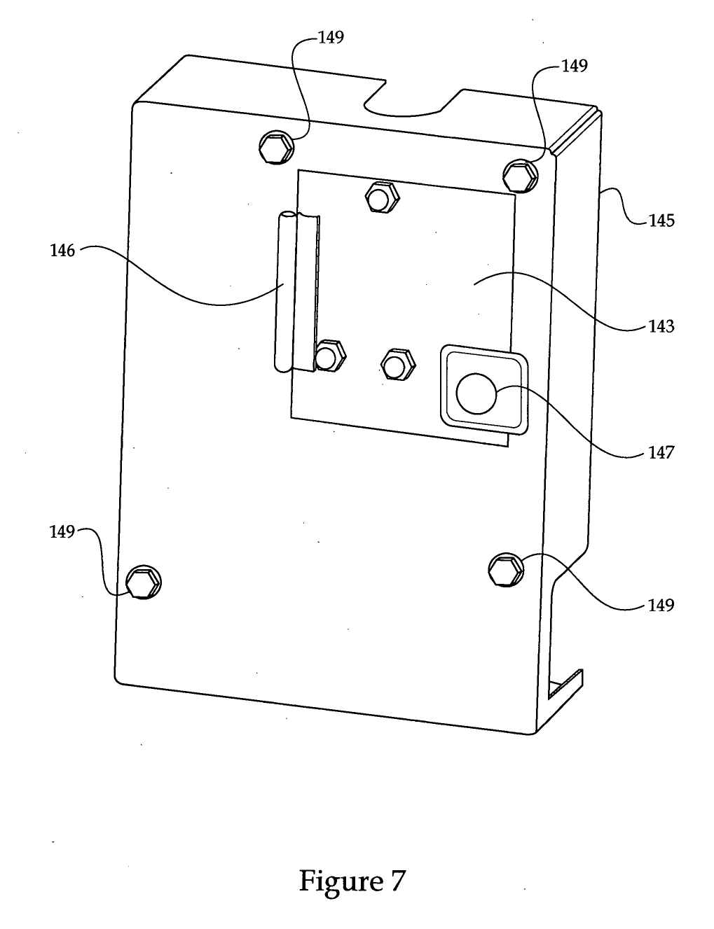

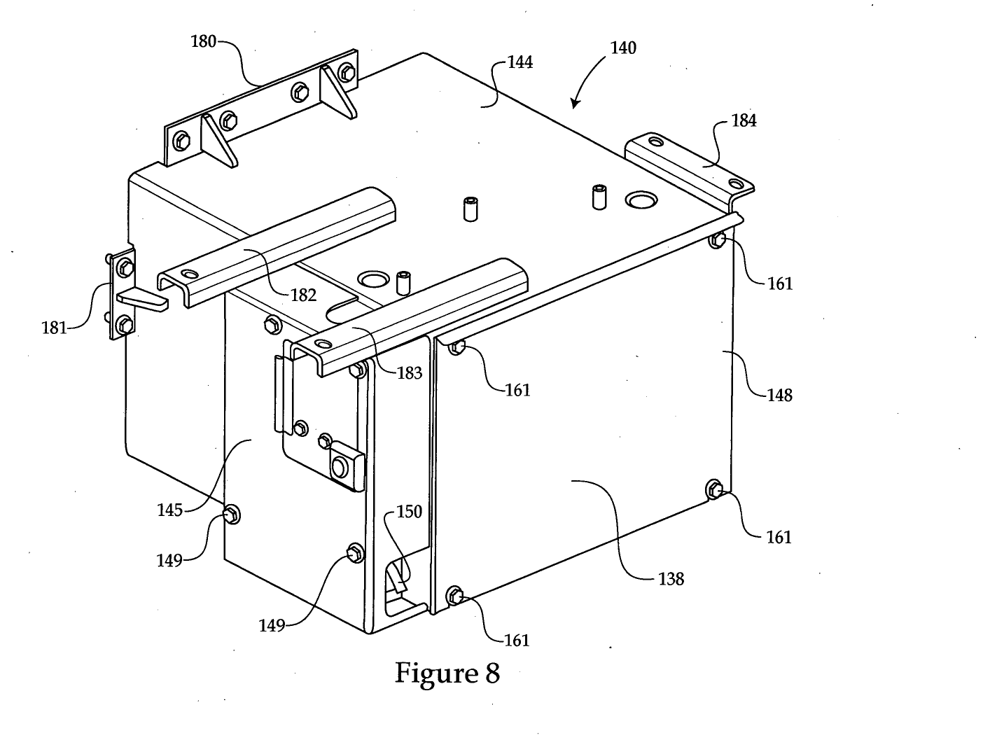

Like the hydraulic service center 40 described earlier, electrical service center 140 may be preassembled as shown in FIG. 8 to include a battery box 144, within which is mounted a battery (not shown) and a relay box 145 that is attached to battery box 144 via appropriate fasteners 149. The battery may be accessed via a battery access panel 148, which may be attached to battery box 144 in any suitable manner, such as via bolts 161. Like the hydraulic service center 40, electrical service center 140 includes a frame 138, and mounts 180, 181, 182, 183 and 184 that allow it to be mounted underneath step 132 in a manner similar to that previously described with respect to the hydraulic service center. FIGS. 6 and 7 show the relay box 145 that includes a relay access door 143 mounted on a hinge 146 and includes a latching mechanism such as a lock 147. This allows the relay reset buttons to be readily accessed through the lockable door 143. An emergency shut off switch 150 is also incorporated into the relay box 145. The emergency shut off switch 150 is located in an easy to reach location for someone on the ground next to the machine, or for an operator dismounting the machine via ladder 30. The emergency shut off switch 150 turns off electrical power to the engine, but maintains electrical power to other systems. A main shut off switch can also be incorporated and provides a means for disconnecting the battery from all electrical circuits of the work machine. A main shut off switch prevents unauthorized use of the machine and is also generally used to keep the battery fresh when the machine is not being used. Having the main shut off switch located inside the electrical service center 40 which can be locked helps restrict access thereto to only authorized persons.

### INDUSTRIAL APPLICABILITY

When manufacturing a work machine, the various filter heads and other hydraulic servicing points must often be individually mounted to the machine chassis as the assembly of the work machine proceeds along an assembly line. Thereafter, filters must be attached to the respective heads. This can be rather expensive and slows the progress of the work machine assembly. The present disclosure addresses this issue by allowing much of the servicing points associated with the hydraulic and/or electrical service centers to be preassembled in respective hydraulic and electrical service centers 40, 140 and brought to the work machine assembly line as pre-assembled units.

Before the preassembled service centers 40 and 140 are brought to the machine 10, the panel 42 may have a plurality of diagnostic taps 58, 59 and grease zerks 73 attached thereto. As the hydraulic service center 40 is brought adjacent to back frame 25, the panel 42 with the various diagnostic tap hoses and grease zerk hoses may be loosely inserted and positioned inside of the service center 40. In addition, the various hydraulic hoses and brake line hoses are inserted through the opening of the hydraulic service center 40, and may be allowed to remain loose until the hydraulic service center is mounted to the work machine 10. The hydraulic service center 40 can then be mounted to the back frame 25 of the work machine 10 via the mounts 80, 82, and 84. The hydraulic service center 40 may also be mounted to the step 32 at 81 and 83. Next, the various hydraulic hoses may be attached to in respective hydraulic components. For instance, the brake line hoses 60 and 61 are attached to brake accumulators 53 and 52, respectively in a conventional manner. The appropriate hydraulic fluid hoses are connected to the hydraulic filter head 70 and case drain filter 71, and the appropriate transmission fluid filter hoses are fluidly connected to transmission filter head 55. Finally, other fluid connections, such as the hydraulic fluid brake hose, may be connected to brake valve 66, and the appropriate fluid hoses connected to eco-drain 56. Panel 42, with taps 58, 59 and zerks 73 already attached, can be mounted to group mount 64 after the frame 38 of service center 40 has been attached to frame 25.

This construction is similar for the electrical service center except that it is mounted on the opposite side of the work machine via its mounts 180 and 181. Step 132 may be attached at mounts 182, 183, and 184. However, instead of fluid hoses being brought into the opening in the electrical service center, electrical wires are brought into the same and may be attached to the already mounted battery relays and shut off switch within the electrical service center after the electrical service center 140 is mounted to work machine 10. The various hoses and wires may also be connected in whole, or in part, before the respective service centers 40, 140 are mounted on the back frame 25. Other hydraulic and/or electrical servicing points could be included in the service centers 40, 140 without departing from the intended scope of the present disclosure. For instance, the hydraulic service center 40 might also include a quick coupler shut off valve, or possibly even an axle oil cooling valve group.

The central location for the respective hydraulic and electrical service centers can save time at the factory during assembly of the work machine, and in the field by making the various servicing points easy to locate. Also, diagnostics can be improved by making the various pressure diagnostic pressure taps located centrally to connect to pressure gauges to diagnose a problem in the field. For instance, pressure taps 58, 59 and grease zerks 73 can be easily accessed by opening the small pressure tap access door 45. On the other hand, electrical relays can be reset at the electrical service center 140 by accessing the same through relay access door 143 on the opposite side of the machine.

The location of the hydraulic and electrical service centers 40, 140 on the work machine 10 as described herein is advantageous for several reasons. First, the service centers 40, 140 are located within reach of a technician standing on the ground. The places all of the service points included therein in an easy to access position so that the technician does not need to lay on the ground, crouch down on the ground, or climb on the machine to reach them. Second, the service points are located away from some of the hot components and moving components on work machine 10 such as the engine, exhaust systems, and bucket. Third, the service centers 40, 140 are located on the side of the machine underneath the steps which lead to the cab doors. In this position, the tires, rear bumper and counterweight, bucket, and linkage of the work machine will not impede the technician's access to the service centers 40, 140. The service centers 40, 140 are also close to the cab so that a technician or operator can access the service centers quickly after dismounting from the cab, or can quickly climb into the cab after performing service center maintenance.

In addition, the structure of the present disclosure facilitates less chance of oil/grease spills during servicing. For instance, a drip pan can be placed inside or below the hydraulic service center 40 to catch any dripping fluids. In another aspect, the servicing decal descriptions may be mounted on the respective insides of the main service panel door and the diagnostic tap door so that a technician can easily reference and confirm the locations of various servicing points, while at the same time the decals are protected from the elements during normal machine operation.

It should be understood that the above description is intended for illustrative purposes only, and is not intended to limit the scope of the present disclosure in any way. Thus, those skilled in the art will appreciate that other aspects, objects, and advantages of the disclosure can be obtained from a study of the drawings, the disclosure and the appended claims.

What is claimed is:

1. A work machine comprising:
a front portion that includes a front frame, a pair of front wheels and a movable bucket;
a back portion that includes a back frame, a pair of back wheels, a cab having a door and a step positioned adjacent and underneath the door, and an engine;
the front and back portions being joined at an articulation joint;
a system comprising one of a plurality of hydraulic components or a plurality of electrical components, the system including a plurality of service points; and
a plurality of the service points being positioned together at a service center positioned underneath the step.

2. The work machine of claim 1 wherein the system includes an electrical system and a hydraulic system;
a plurality of hydraulic servicing points being grouped at a common hydraulic service center underneath a step on one side of the back portion; and
a plurality of electrical servicing points being grouped at a common electrical service center underneath a step on an opposite side of the back portion.

3. The work machine of claim 1 wherein the service center includes a service center frame connected to the back frame; and
a ladder attached to the service center frame.

4. The work machine of claim 3 wherein the service center frame is a portion of an enclosure that includes a small door on a side; and
the ladder is attached to a large door on an other side of the enclosure.

5. The work machine of claim 4 including a plurality of diagnostic pressure taps grouped together in the enclosure, and being accessible when the small door is open; and
a case drain filter, a hydraulic fluid filter, a transmission filter, and at least one brake accumulators being mounted in the enclosure, and being accessible when the large door is open.

6. The work machine of claim 5 including an ecology drain valve and a parking brake valve attached to the enclosure; and
at least one grease zerk positioned adjacent the pressure taps, and being accessible when the small door is open.

7. The work machine of claim 2 wherein the common electrical service center includes a relay panel, a battery box and an emergency shut off switch.

8. A hydraulic service center comprising:
a service center box that includes a mount and at least one door;
a plurality of hydraulic servicing points attached inside the box, and the hydraulic servicing points including a hydraulic fluid filter, a case drain filter, a transmission fluid filter and at least one brake accumulator.

9. The hydraulic service center of claim 8 wherein the at least one door includes a diagnostic tap door; and
the service center box includes a diagnostic pressure tap group mount adjacent the diagnostic tap door, within the service center box.

10. The hydraulic service center of claim 9 including a parking brake fluid valve attached to the service center box.

11. The hydraulic service center of claim 10 wherein the at least one door includes a service main door that is larger than, and on a side different from, the diagnostic tap door.

12. The hydraulic service center of claim 11 wherein the service main door includes at least one ladder mount.

13. A method of assembling a work machine, comprising:
attaching a hydraulic service center underneath a step of a back portion of a work machine body, which includes a front portion joined to the back portion via an articulation joint;
attaching a plurality of hydraulic fluid system hoses to at least one hydraulic filter mounted inside the hydraulic service center;
attaching at least one brake line hose to at least one brake accumulator mounted inside the hydraulic service center; and
attaching at least one transmission fluid hose to a transmission filter mounted inside the hydraulic service center.

14. The method of claim 13 including:
pre-assembling the at least one hydraulic filter, the at least one brake accumulator and the transmission filter into the hydraulic service center before the hydraulic service center is attached to the back portion.

15. The method of claim 14 including:
attaching a plurality of diagnostic pressure taps to a panel; and
mounting the panel in the hydraulic service center.

16. The method of claim 15 including:
attaching at least one grease zerk to the panel before the panel is mounted.

17. The method of claim 16 including:
attaching a parking brake valve to the hydraulic service center.

18. The method of claim 16 including:
attaching a ladder to the hydraulic service center.

19. The method of claim 16 including:
protecting contents of the hydraulic service center at least in part by closing a diagnostic tap door and a service main door.

20. The method of claim 16 including:
attaching an ecology drain in the hydraulic service center.
